(19) United States
(12) Patent Application Publication
(10) Pub. No.: US 2010/0148124 A1
(43) Pub. Date: Jun. 17, 2010

(54) PROCESS FOR PREPARING POLYTHIOPHENES

(75) Inventors: Knud Reuter, Krefeld (DE); Stephan Kirchmeyer, Leverkusen (DE)

Correspondence Address: CONNOLLY BOVE LODGE & HUTZ, LLP, P O BOX 2207, WILMINGTON, DE, 19899, US

(73) Assignee: H.C. Starck GmbH, Goslar (DE)

(21) Appl. No.: 12/161,087

(22) PCT Filed: Jan. 18, 2007
(86) PCT No.: PCT/EP2007/000399

§ 371 Date: Aug. 27, 2008

(30) Foreign Application Priority Data
Jan. 20, 2006 (DE) 102006002797.3

(51) Int. Cl. H01B 1/12; C08G 61/12

(52) U.S. Cl. 252/500; 528/378

(57) ABSTRACT

The invention is related to a process for preparing polythiophenes. The polythiophenes are prepared by oxidatively polymerizing a thiophene or thiophene derivative with an oxidizing agent, wherein the oxidizing agent used is at least one hypervalent iodine compound. The invention further relates to a process for producing dispersions and a process for producing conductive layers.

The invention relates to a novel process for preparing polythiophenes, especially conductive polythiophenes, and to the use of hypervalent iodine compounds as oxidizing agents in the oxidative polymerization of thiophenes.

The compound class of the π-conjugated polymers has been the subject of numerous publications in the last few decades. They are also referred to as conductive polymers or as synthetic metals.

Conductive polymers are gaining increasing economic significance, since polymers have advantages over metals with regard to processability, weight and the controlled establishment of properties by chemical modification. Examples of known π-conjugated polymers are polypyrroles, polythiophenes, polyanilines, polyacetylenes, polyphenylenes and poly(p-phenylene-vinylenes). Layers of conductive polymers have various industrial uses.

Conductive polymers are prepared by chemical or electrochemical oxidative means from precursors for the preparation of conductive polymers, for example, optionally substituted thiophenes, pyrroles and anilines and their particular derivatives which may be oligomeric. Chemically oxidative polymerization in particular is widespread, since it can be achieved in a technically simple manner in a liquid medium or on various substrates.

A particularly important and industrially utilized polythiophene is poly(ethylene-3,4-dioxythiophene) which, in its oxidized form, has very high conductivities and is described, for example, in EP 339 340 A2. An overview of numerous poly(alkylene-3,4-dioxythiophene) derivatives, especially poly(ethylene-3,4-dioxythiophene) derivatives, their monomer units, syntheses and applications, is given by L. Groenendaal, F. Jonas, D. Freitag, H. Pielartzik and J. R. Reynolds, Adv. Mater. 12 (2000), p. 481-494.

Oxidizing agents for preparing poly(ethylene-3,4-dioxythiophene) (PEDT or PEDOT, referred to hereinafter as PEDT) from ethylene-3,4-dioxythiophene (EDT or EDOT, referred to hereinafter as EDT) which are common in industry and/or specified in the literature and patent literature stem, for example, from the classes of the peroxidic compounds or of the transition metal salts.

Prior art peroxidic compounds suitable as oxidizing agents are, for example, hydrogen peroxide, sodium perborate, persulfates (peroxodisulfate) of the alkali metals, such as sodium persulfate or potassium persulfate, or ammonium persulfate. Oxidation with air or oxygen is effected in a chemically related manner.

Such oxidizing agents are suitable particularly for preparing polythiophene dispersions, especially polyethylene-3,4-dioxythiophene) dispersions, as described in EP-A 440 957. Such aqueous dispersions preferably contain polymeric sulfonic acids as polyanions, which assume the role of the counterions for the poly(ethylene-3,4-dioxythiophene) cations.

A disadvantage of these essentially peroxidic oxidizing agents is the restriction to aqueous systems and a tendency to oxidize the sulfur atoms of the thiophene ring, which can lead under some circumstances to a limit in the achievable electrical conductivity or to the formation of by-products. They are also unsuitable for preparing conductive polymers from thiophenes containing further sulfur atoms, for example ethylene-3,4-oxythiathiophene, since the sulfur atom of the 6-membered ring is oxidized to form a sulfone group, and the thiophene product formed can no longer be polymerized oxidatively. Moreover, a reproducible reaction with peroxidic oxidizing agents is typically only possible when suitable catalysts are added in the form of transition metal salts, such as iron(II) sulfate or iron(III) sulfate. The residues of these transition metal ions remaining in the product generally have to be removed to achieve optimal properties of the conductive polythiophenes, for example by means of ion exchangers.

Prior art transition metal salts suitable as oxidizing agents are, for example, iron(III) salts such as FeCl₃, iron(III) perchlorate, iron(III) sulfate, iron(III) tosylate or other iron(III) sulfonates, for example iron(III) camphorsulfonate, cerium(IV) salts, potassium permanganate, potassium dichromate or copper(II) salts such as copper (II) tetrafluoroborate.

A disadvantage of oxidizing agents based on such transition metal salts is the formation of salts of these metals in lower oxidation states (for example Fe(II) salts, Mn(IV) compounds, Cu(I) salts) as inevitable by-products. In the case of industrial use of conductive layers which are prepared on the basis, for example, of EDT and Fe(III) salts, for example for use in capacitors, these salts or the transition metal ions in lower oxidation states remaining in the conductive layer are disruptive and generally have to be washed out as completely as possible. For this purpose, several washing operations are often required. Otherwise, the crystallization of the salts in the course of time can lead to an increased series resistance as a result of contact resistances which occur. In addition, the crystals can damage the dielectric or the outer contact layers in the case of mechanical stress on the capacitor, such that the residual current rises.

There is thus a need for oxidizing agents for preparing polythiophenes by means of chemical oxidative polymerization, which do not have the disadvantages mentioned.

It was thus an object of the present invention to discover suitable oxidizing agents for the oxidative polymerization of thiophenes and to discover a process for preparing polythiophenes by means of chemical oxidative polymerization, without any requirement for subsequent complete removal of transition metal ions.

This object has been found, surprisingly, by the use of hypervalent iodine compounds as oxidizing agents for preparing polythiophenes by means of oxidative polymerization. In the case of use of the hypervalent iodine compounds, no additional transition metal ion-containing catalyst is required and thus there is no complete and complicated removal of transition metal ions.

The present invention thus provides a process for preparing polythiophenes by oxidatively polymerizing thiophenes or thiophene derivatives, characterized in that the oxidizing agent used is at least one hypervalent iodine compound.

Preferably, the process according to the invention is used to prepare polythiophenes containing repeat units of the general formula (I)

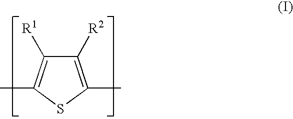

in which
R¹ and R² are each independently H, an optionally substituted C₁-C₁₈-alkyl radical or an optionally substituted C₁-C₁₈-alkoxy radical or
R¹ and R² together are an optionally substituted C₁-C₁₈-alkylene radical, an optionally substituted C₁-C₁₈-alkylene radical in which one or more carbon atom(s) may be replaced by one or more identical or different heteroatoms selected from O and S, preferably a C₁-C₈-dioxyalkylene radical, an optionally substituted C₁-C₈-oxythiaalkylene radical or an optionally substituted C₁-C₈-dithiaalkylene radical, or an optionally substituted C₁-C₈-alkylidene radical in which at least one carbon atom is optionally replaced by a heteroatom selected from O and S,
   by oxidatively polymerizing thiophenes of the general formula (II)

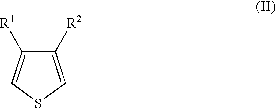

where R¹ and R² are each as defined for the general formula (I).

Particular preference is given to using the process according to the invention to prepare polythiophenes containing repeat units of the general formula (I-a) and/or (I-b)

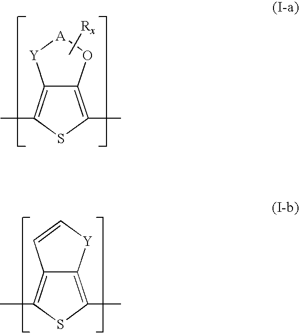

in which
A is an optionally substituted C₁-C₅-alkylene radical, preferably an optionally substituted C₂-C₃-alkylene radical,
Y is O or S,
R is a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x is an integer of 0 to 8, preferably of 0 or 1, and
   in the case that a plurality of R radicals is bonded to A, they may be the same or different,
   by oxidatively polymerizing thiophenes of the general formula (II-a) and/or (II-b),

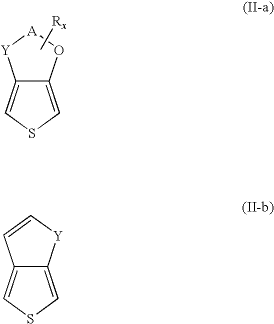

in which A, Y, R and x are each as defined for the general formulae (II-a) and (II-b).

The general formulae (I-a) and (II-a) should be interpreted such that x substituents R can be bonded to the alkylene radical A.

Polythiophenes containing repeat units of the general formula (II-a) are preferably those containing repeat units of the general formula (II-a-1) and/or (II-a-2),

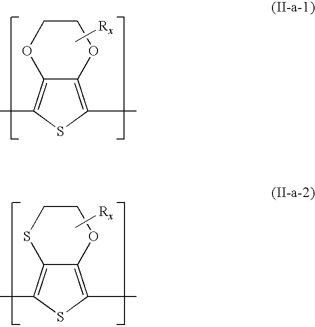

in which
R and x are each as defined above.

These are more preferably those polythiophenes containing repeat units of the general formula (II-aa-1) and/or (II-aa-2)

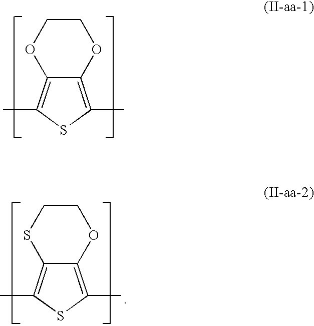

In particularly preferred embodiments, the polythiophene with repeat units of the general formula (II-a) and/or (II-b) is poly(3,4-ethylenedioxythiophene), poly(3,4-ethyleneoxythiathiophene) or poly(thieno[3,4-b]thiophene), i.e. a homopolythiophene formed from repeat units of the formula (II-aa-1), (II-aa-2) or (II-b).

In further particularly preferred embodiments, the polythiophene with repeat units of the general formula (II-a) and/or (II-b) is a copolymer formed from repeat units of the formula (II-aa-1) and (II-aa-2), (II-aa-1) and (II-b), (II-aa-2) and (II-b), or (II-aa-1), (II-aa-2) and (II-b), preference being given to copolymers formed from repeat units of the formula (II-aa-1) and (II-aa-2), and also (II-aa-1) and (II-b).

The polythiophenes may be neutral or cationic. In preferred embodiments, they are cationic, “cationic” relating only to the charges which reside on the polythiophene main chain. According to the substituent on the R radicals, the polythiophenes may bear positive and negative charges in the structural unit, in which case the positive charges are present on the polythiophene main chain and the negative charges may be present on the R radicals substituted by sulfonate or carboxylate groups. In this case, the positive charges of the polythiophene main chain may be partly or fully balanced by any anionic groups present on the R radicals. Viewed overall, the polythiophenes in these cases may be cationic, neutral or even anionic. Nevertheless, they are all considered to be cationic polythiophenes in the context of the invention, since the positive charges on the polythiophene main chain are crucial. The positive charges are not shown in the formulae, since their exact number and position cannot be determined readily. The number of positive charges is, however, at least 1 and at most n, where n is the total number of all repeat units (identical or different) within the polythiophene.

Preference is given to using the process according to the invention to prepare conductive polythiophenes with a specific conductivity of more than 10⁻³ Scm⁻¹, more preferably of 10⁻² Scm⁻¹.

To compensate for the positive charge, where this is not already done by the optionally sulfonate- or carboxylate-substituted and hence negatively charged R radicals, the cationic polythiophenes require anions as counterions.

Preference is given to carrying out the process according to the invention in the presence of at least one counterion.

Useful counterions include monomeric or polymeric anions, the latter also referred to hereinafter as polyanions.

Preferred polymeric anions are, for example, anions of polymeric carboxylic acids, such as polyacrylic acids, polymethacrylic acids or polymaleic acids, or polymeric sulfonic acids, such as polystyrenesulfonic acids and polyvinylsulfonic acids. These polycarboxylic acids and polysulfonic acids may also be copolymers of vinylcarboxylic acids and vinylsulfonic acids with other polymerizable monomers, such as acrylic esters and styrene. They may, for example, also be partly fluorinated or perfluorinated polymers containing SO₃⁻M⁺ or COO⁻M⁺ groups, where M⁺ is, for example, ⁺, Li⁺, Na⁺, K⁺, Rb⁺, Cs⁺ or NH₄⁺, preferably H⁺, Na⁺, or K⁺. Such a partly fluorinated or perfluorinated polymer containing SO₃⁻M⁺ or COO⁻M⁺ groups may, for example, be Nafion® which is, for example, commercially available. Mixtures of one or more of these polymeric anions are also useful.

Particular preference is given, as the polymeric anion, to the anion of polystyrenesulfonic acid (PSS) as the counterion.

The molecular weight of the polyacids which afford the polyanions is preferably from 1000 to 2 000 000, more preferably from 2000 to 500 000. The polyacids or their alkali metal salts are commercially available, for example, polystyrenesulfonic acids and polyacrylic acids or else are preparable by known processes (see, for example, Houben Weyl, Methoden der organischen Chemie [Methods of organic chemistry], Vol. E 20, Makromolekulare Stoffe [Macromolecular substances], Part 2, (1987), p. 1141, ff.)

The monomeric anions used are, for example, those of C₁-C₂₀ alkanesulfonic acids, such as those of methanesulfonic acid, ethanesulfonic acid, propane-sulfonic acid, butanesulfonic acid or higher sulfonic acids, such as those of dodecanesulfonic acid, of aliphatic perfluorosulfonic acids, such as those of trifluoromethanesulfonic acid, of perfluorobutane-sulfonic acid or of perfluorooctanesulfonic acid, of aliphatic C₁-C₂₀-carboxylic acids such as those of 2-ethylhexylcarboxylic acid, of aliphatic perfluoro-carboxylic acids, such as those of trifluoroacetic acid or of perfluorooctanoic acid, and of aromatic sulfonic acids optionally substituted by C₁-C₂₀-alkyl groups, such as those of benzenesulfonic acid, o-toluene-sulfonic acid, p-toluenesulfonic acid, dodecylbenzene-sulfonic acid, dinonylnaphthalenesulfonic acid or dinonylnaphthalenedisulfonic acid, and of cycloalkane-sulfonic acids such as camphorsulfonic acid or tetrafluoroborates, hexafluorophosphates, perchlorates, hexafluoroantimonates, hexafluoroarsenates or hexachloroantimonates.

Particular preference is given to the anions of p-toluenesulfonic acid, methanesulfonic acid or camphorsulfonic acid.

It is also possible for anions of the oxidizing agent used or anions formed therefrom after the reduction to serve as counterions, such that an addition of additional counterions is not absolutely necessary.

Cationic polythiophenes which contain anions as counterions for charge compensation are often also referred to in the technical field as polythiophene/(poly)anion complexes.

Preferred thiophenes of the general formula (II-a) are those of the general formula (II-a-1) and/or (II-a-2)

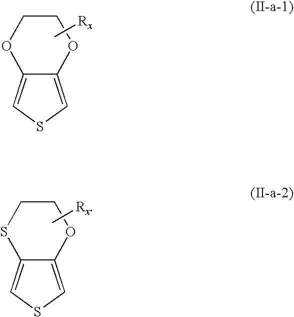

The thiophenes of the general formula (II-a) used are more preferably those of the general formula (II-a-1) and/or (II-aa-2)

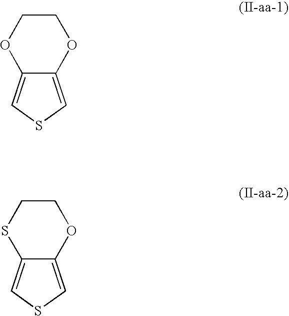

In the context of the invention, derivatives of the thiophenes detailed above are understood to mean, for example, dimers or trimers of these thiophenes. Higher molecular weight derivatives, i.e. tetramers, pentamers, etc., of the monomeric precursors are also possible as derivatives. The derivatives can be formed either from identical or different monomer units and be used in pure form and also in a mixture with one another and/or with the abovementioned thiophenes. Oxidized or reduced forms of these thiophenes and thiophene derivatives are also encompassed by the term “thiophenes” and “thiophene derivatives” within the context of the invention, provided that the same conductive polymers form when they are polymerized as in the case of the thiophenes and thiophene derivatives detailed above.

Processes for preparing the thiophenes and derivatives thereof are known to those skilled in the art and are described, for example, in L. Groenendaal, F. Jonas, D. Freitag, H. Pielartzik and J. R. Reynolds, Adv. Mater. 12 (2000), p. 481-494 and literature cited therein.

The thiophenes can optionally be used in the form of solutions. Suitable solvents include in particular the following organic solvents which are inert under the reaction conditions: aliphatic alcohols such as methanol, ethanol, i-propanol and butanol; aliphatic ketones such as acetone and methyl ethyl ketone; aliphatic carboxylic esters such as ethyl acetate and butyl acetate; aromatic hydrocarbons such as toluene and xylene; aliphatic hydrocarbons such as hexane, heptane and cyclohexane; chlorohydrocarbons such as dichloromethane and dichloroethane; aliphatic nitriles such as acetonitrile, aliphatic sulfoxides and sulfones such as dimethyl sulfoxide and sulfolane; aliphatic carboxamides such as methyl acetamide, dimethyl acetamide and dimethyl formamide; aliphatic and araliphatic ethers such as diethyl ether and anisole. In addition, it is also possible to use water or a mixture of water with the aforementioned organic solvents as the solvent. Preferred solvents are alcohols and water, and also mixtures comprising alcohols or water or mixtures of alcohols and water.

Thiophenes which are liquid under the oxidation conditions can also be polymerized in the absence of solvents.

C₁-C₅-alkylene radicals A are, in the context of the invention: methylene, ethylene, n-propylene, n-butylene or n-pentylene; C₁-C₈-alkylene radicals are additionally n-hexylene, n-heptylene and n-octylene. In the context of the invention, C₁-C₈-alkylidene radicals are C₁-C₈-alkylene radicals which contain at least one double bond and have been detailed above. In the context of the invention, C₁-C₈-dioxyalkylene radicals, C₁-C₈-oxythiaalkylene radicals and C₁-C₈-dithiaalkylene radicals are the C₁-C₈-dioxyalkylene radicals, C₁-C₈-oxythiaalkylene radicals and C₁-C₉-dithiaalkylene radicals corresponding to the C₁-C₈-alkylene radicals detailed above. In the context of the invention, C₁-C₁₈-alkyl represents linear or branched C₁-C₁₈-alkyl radicals, for example methyl, ethyl, n- or isopropyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl, C₅-C₁₂-cycloalkyl represents C₅-C₁₂-cycloalkyl radicals such as cyclopentyl, cyclodecyl, cycloheptyl, cyclooctyl, cyclononyl or cyclodecyl, C₅-C₁₄-aryl represents C₆-C₁₄-aryl radicals such as phenyl or naphthyl, and C₇-C₁₈-aralkyl represents C₇-C₁₈-aralkyl radicals, for example, benzyl, o-, m-, p-tolyl, 2,3-, 2,4-, 2,5-, 2,6-, 3,4-, 3,5-xylyl or mesityl. In the context of the invention, C₁-C₁₈-alkoxy radicals are the alkoxy radicals corresponding to the C₁-C₁₈-alkyl radicals detailed above. The above enumeration serves to illustrate the invention by way of example and should not be considered to be exclusive.

Any further substituents of the above radicals may be numerous organic groups, for example, alkyl, cycloalkyl, aryl, halogen, ether, thioether, disulfide, sulfoxide, sulfone, sulfonate, amino, aldehyde, keto, carboxylic ester, carboxylic acid, carbonate, carboxylate, cyano, alkylsilane and alkoxysilane groups, and also carboxamide groups.

In the context of the present invention, hypervalent iodine compounds are understood to mean organic iodine compounds in which the iodine atom is more than monocoordinated, i.e. is at least bicoordinated, and is not present in the formal oxidation state of −1 or 0, Such iodine compounds are described, for example, in “Hypervalent Iodine in Organic Synthesis” by A. Varvoglis (Academic Press, San Diego/London 1997). In addition, in the context of the invention, hypervalent iodine compounds are understood to mean inorganic iodine compounds in which the iodine atom is more than monocoordinated, i.e. is at least bicoordinated, and is not present in the formal oxidation state of −1 or 0. Preferred inorganic hypervalent iodine compounds are those in which the iodine atom is present in the formal oxidation state of +1, +3, +5 or +7. Such hypervalent inorganic iodine compounds are, for example, iodic acid and salts thereof, for example, alkali metal or alkaline earth metal salts such as sodium iodate and potassium iodate (oxidation state +5), periodic acid and salts thereof, for example, alkali metal or alkaline earth metal salts such as sodium periodate (oxidation state +7), or the anhydrides which are derived in a formal sense from these oxygen acids of iodine, for example, iodine pentoxide (I₂O₅). Particularly preferred inorganic hypervalent iodine compounds are those in which the iodine atom is present in the formal oxidation state of +5.

Preferred organic hypervalent iodine compounds are, for example, aryl-iodine(III) compounds, for example, bis(acyloxy)iodoaromatics such as diacetoxyiodobenzene (III) or bis(trifluoroacetoxy)iodobenzene (IV), difluoro- and dichloroiodobenzene (V), iodosylbenzene (VI), hydroxy(tosyloxy)iodobenzene (“Koser's reagent” (VII)), and also iodylbenzene (VIII), 1-oxido-1-hydroxybenzoiodoxol-3(1H)-one (“o-iodylbenzoic acid”, (IX)), 1,1,1-triacetoxy-1,1-dihydro-1,2-benzoiodoxol-3(1H)-one (“Dess-Martin reagent” or “Dess-Martin periodinane”, (X)), and also aryliodonium salts, for example from the group of the diaryliodonium salts diphenyliodonium chloride (XI) or phenyl-4-methoxyphenyliodonium triflate (XII), mixed alkylaryliodonium salts which may optionally be partly fluorinated or perfluorinated, and further iodine(III) salts of organic acids, for example iodine(III) salts of optionally partly fluorinated or perfluorinated C₁-C₁₈-alkylsulfonic acids or C₁-C₁₈-alkylcarboxylic acids such as iodine tris(trifluoroacetate) or iodine tris(trifluoromethanesulfonate). The compounds of the formulae (III) to (XII) are shown by way of example below:

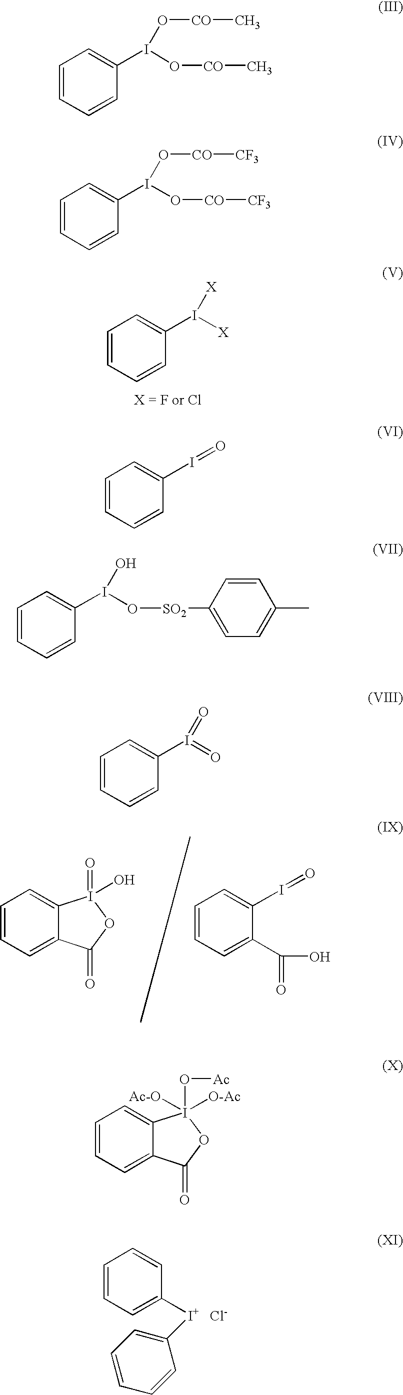

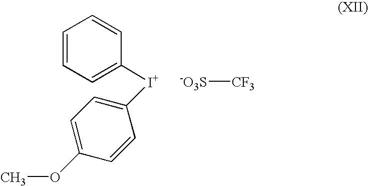

Particularly preferred hypervalent iodine compounds are sodium iodate, potassium iodate, sodium periodate, di(acetoxy)iodobenzene, bis(trifluoroacetoxy) iodobenzene and Koser's reagent (hydroxy(tosyloxy) iodobenzene.

According to the oxidizing agent used and desired polymerization time, the oxidative polymerization of the thiophenes of the formula (II) is undertaken generally at temperatures of from −10 to +250° C., preferably at temperatures of from 0 to 200° C., more preferably at temperatures of from 0 to 100° C. According to the batch size, polymerization temperature and oxidizing agent, the polymerization time may be from a few minutes up to several days. In general, the polymerization time is between 30 minutes and 150 hours.

The oxidative polymerization of the thiophenes of the formula (II) requires, theoretically per mole of thiophene, 2.25 equivalents of oxidizing agent (see, for example, J. Polym. Sc. Part A, Polymer Chemistry Vol. 26. p. 1287 (1988)). However, it is also possible to use oxidizing agents in an amount lower than that required theoretically. Preference is given to using thiophenes and oxidizing agents in a weight ratio of from 4:1 to 1:20. In preferred embodiments, the oxidizing agent is, however, employed in a certain excess, for example an excess of from 0.1 to 2 equivalents per mole of thiophene. Particular preference is thus given to using more than 2.25 equivalents of oxidizing agent per mole of thiophene.

It is extremely surprising that the hypervalent iodine compounds to be used in accordance with the invention are suitable for oxidative polymerization of thiophenes. It is known, for example, that sulfur compounds are oxidized with sodium periodate to give sulfoxides (N. J. Leonard, C. R. Johnson, J. Org. Chem 27 (1962), p. 282; K.-T Liu, Y.-C. Tong, J. Org. Chem 43 (1978), p. 2717). Organic hypervalent iodine compounds also oxidize sulfides to sulfoxides and sulfones (see, for example, R.-Y. Yang, L.-X Dai, Synth. Commun. 24 (1994), p. 2229 and the comment “Sulphides are oxidized readily by most hypervalent iodine reagents” in “Hypervalent Iodine in Organic Synthesis” by A. Varvoglis, Academic Press, San Diego/London, 1997, p. 94). In addition, it is known that hypervalent iodine compounds are frequently suitable for oxidizing alcohols to carbonyl compounds (see, for example “Hypervalent Iodine in Organic Synthesis” by A. Varvoglis, p. 70, 84, 206-208), whereas, in accordance with the present invention, especially alcohols or mixtures comprising alcohols, in preferred embodiments, are very suitable solvents for the oxidative polymerization of the thiophenes.

The invention further provides for the use of hypervalent iodine compounds for oxidative polymerization of thiophenes or their derivatives detailed above. Particular preference is given to the use of sodium iodate, sodium periodate, di(acetoxy) iodobenzene, bis(trifluoroacetoxy)iodobenzene and Koser's reagent.

The oxidative polymerization of polythiophenes in the process according to the invention can be used for different applications of the resulting thiophenes. It is, for example, possible to prepare stable dispersions comprising polythiophenes or else directly to prepare conductive layers comprising polythiophenes, each of which is amenable to numerous further applications.

The present invention thus further provides a process for preparing dispersions comprising optionally substituted polythiophenes by oxidatively polymerizing optionally substituted thiophenes or thiophene derivatives in the presence of at least one solvent and optionally of at least one counterion, characterized in that the oxidizing agent used is at least one hypervalent iodine compound.

For the polymerization, the thiophenes or derivatives thereof, oxidizing agent and optionally counterions are preferably dissolved in the solvent(s) and stirred at the intended polymerization temperature until the polymerization is complete.

Thiophenes and counterions, especially in the case of polymeric counterions, are used in such an amount that counterion(s) and polythiophene(s) are present thereafter in a weight ratio of from 0.5:1 to 50:1, preferably from 1:1 to 30:1, more preferably from 2:1 to 20:1. The weight of the polythiophenes corresponds here to the initial weight of the monomers used under the assumption that there is complete conversion in the polymerization.

The present invention likewise further provides a process for producing conductive layers comprising optionally substituted polythiophenes, characterized in that optionally substituted thiophenes or thiophene derivatives are oxidatively polymerized on a suitable substrate with at least one hypervalent iodine compound as an oxidizing agent in the presence or absence of at least one solvent.

The latter process—often also referred to in the technical field as in situ polymerization—is, for example, also used to produce layers which are part of capacitors, for example, to produce the solid electrolyte or the electrodes.

The substrate may, for example, be glass, flexible glass or plastic to be coated correspondingly in the form of shaped bodies or films, and also other shaped bodies to be coated, for example anodes of capacitors. According to the intended application for the polythiophenes synthesized by the process according to the invention, the use of different hypervalent iodine compounds may be advantageous.

For example, water-soluble inorganic hypervalent iodine compounds, such as iodic acid and salts thereof, for example, alkali metal or alkaline earth metal salts such as sodium iodate and potassium iodate (oxidation state +5), periodic acid and salts thereof, for example, alkali metal or alkaline earth metal salts such as sodium periodate (oxidation state +7), or the anhydrides which are derived in a formal sense from these oxygen acids of iodine, for example, iodine pentoxide (I₂O₅) are suitable for the preparation of aqueous dispersions comprising the polythiophenes detailed above. Preference is given here to sodium iodate or sodium periodate. A particularly preferred dispersion preparable by this variant is an aqueous dispersion comprising poly(3,4-ethylenedioxythiophene) and polystyrenesulfonic acid (PEDT/PSS complex).

Hypervalent iodine compounds soluble in nonaqueous solvents, for example, di(acetoxy)iodobenzene, bis(trifluoroacetoxy)iodobenzene, Koser's reagent or iodosobenzene are particularly suitable for the preparation of nonaqueous dispersions or for the preparation of polythiophene layers polymerized in situ, preferably poly(3,4-ethylenedioxythiophene) layers (PEDT layers) which are typically obtained from organic solvents, optionally in the presence of suitable counterions or acids which afford counterions.

In the processes detailed above for preparing dispersions and conductive layers, the polythiophenes already mentioned are obtained, and the thiophenes and derivatives thereof, hypervalent iodine compounds, counterions, etc. which have been mentioned already, can be used. Areas of preference apply analogously.

Preferred nonaqueous solvents for the preparation of nonaqueous dispersions or polythiophene layers polymerized in situ may, for example, be alcohols such as methanol, ethanol, n-propanol, isopropanol, n-butanol, ethylene glycol, diethylene glycol, particular preference among these alcoholic solvents being given to ethanol and n-butanol. However, it is also possible to use solvents from the group of the aliphatic and aromatic hydrocarbons, such as hexane, heptane, octane, toluene or xylene, of the halogenated aliphatic or aromatic hydrocarbons, such as methylene chloride, chloroform, chlorobenzene or o-dichlorobenzene, and also ethers such as diethyl ether, diisopropyl ether, tert-butyl methyl ether, tetrahydrofuran (THF), dioxane or diglyme, amides such as dimethylformamide, dimethylacetamide or N-methylpyrrolidone, alone or in a mixture with alcohols. In a low proportion, i.e. preferably less than 5% by weight, water may also be present.

For the preparation of aqueous dispersions, it is likewise possible for small proportions, i.e. preferably less than 10% by weight, of the above solvents, especially alcohols, to be present in the water.

For the preparation of stable aqueous polythiophene dispersions, it is advantageous to use water-soluble counterions of those detailed above, preferably sulfonic acids, especially polymeric sulfonic acids, for example polystyrenesulfonic acid (PSS).

For the preparation of nonaqueous polythiophene dispersions or the in situ preparation of layers from organic solution, it is advantageous to use counterions sufficiently soluble in the solvents, preferably sulfonic acid. These advantageously may be monomeric counterions, for example p-toluenesulfonic acid, dodecylbenzenesulfonic acid or camphorsulfonic acid.

The examples which follow serve to illustrate the invention and should not be interpreted as a restriction.

### EXAMPLES

### Example 1

### Preparation of a Poly(3,4-Ethylenedioxythiophene) Dispersion (PEDT:PSS Dispersion) with Sodium Iodate as the Oxidizing Agent

A solution of 5.0 g of PSS (molecular weight M_{w}=48 000), 2.0 g of EDT and 1.178 g of sodium iodate in 489 g of water was stirred at 50° C. for 100 h. Thereafter, the deep blue reaction mixture was deionized with 41 g each of cation exchanger and anion exchanger (Lewatit® S 100 and Lewatit® MP 62) for 8 h, and then the ion exchange resin was filtered off.

The resulting formulation was mixed with acetone, methanol and water in a 1:1:1:1 weight ratio and applied with a doctor blade to a polyethylene terephthalate) film with a wet film thickness of 60 μm. After drying at 23° C., the surface resistance of the light blue, conductive coating was 46 kΩ/sq.

### Example 2

### Preparation of a PEDT:PSS Dispersion with Sodium Periodate as the Oxidizing Agent

A solution of 5.0 g of PSS (molecular weight M_{w}=48 000), 2.0 g of EDT and 0.937 g of sodium periodate in 489 g of water was stirred at 23° C. for 16 h. Thereafter, the deep blue reaction mixture was deionized with 41 g each of cation exchanger and anion exchanger (Lewatit® S 100 and Lewatit® MP 62) for 8 h, and then the ion exchange resin was filtered off.

The resulting formulation was mixed with acetone, methanol and water in a 1:1:1:1 weight ratio and applied with a doctor blade to a poly(ethylene terephthalate) film with a wet film thickness of 60 μm to give a light blue, conductive coating.

### Example 3

### In Situ Polymerization of 3,4-Ethylenedioxythiophene (EDT) with di(acetoxy)iodobenzene as the Oxidizing Agent

5.66 g of a 10% solution of di(acetoxy)iodobenzene in ethanol, 0.2 g of EDT and 2.68 g of a 50% solution of p-toluenesulfonic acid monohydrate in ethanol were mixed and applied with a doctor blade to a polycarbonate film with a wet film thickness of 12 μm. After drying at 85° C. for 1 h, the film was washed briefly with water; thereafter, a conductive blue film with a surface resistance of 7.66 kΩ/sq was obtained.

In Situ Polymerization of EDT with Bis(Trifluoro-Acetoxy)Iodobenzene as the Oxidizing Agent

1.51 g of a 50% solution of bis(trifluoroacetoxy) iodobenzene in ethanol, 0.2 g of EDT and 2.68 g of a 50% solution of p-toluenesulfonic acid monohydrate in ethanol were mixed and applied with a doctor blade to a polycarbonate film with a wet film thickness of 12 μm. After drying at 85° C. for 1 h, the film was washed briefly with water; thereafter, a conductive blue film with a surface resistance of 6.92 kΩ/sq was obtained.

### Example 5

### In Situ Polymerization of EDT with Hydroxytosyloxyiodobenzene (Koser's Reagent) as the Oxidizing Agent

2.76 g of a 25% solution of hydroxytosyloxyiodobenzene (Koser's reagent) in ethanol, 0.2 g of EDT and 2.68 g of a 50% solution of p-toluenesulfonic acid monohydrate in ethanol were mixed and applied with a doctor blade to a polycarbonate film with a wet film thickness of 12 μm. After drying at 60° C. for 3 h, the film was washed briefly with water; thereafter, a conductive blue-green film with a surface resistance of 1.45 kΩ/sq was obtained.

### Example 6

### Preparation of a Poly(3,4-Ethyleneoxythiathiophene) Dispersion (PEOTT:PSS Dispersion) with Sodium Iodate as the Oxidizing Agent

A solution of 1.06 g of PSS (molecular weight M_{w}=48 000), 0.47 g of EOTT and 0.25 g of sodium iodate in 103.7 g of water was stirred at 50° C. for 7 d. Thereafter, the deep blue reaction mixture was deionized with 9 g each of cation exchanger and anion exchanger (Lewatit® S 100 and Lewatit® MP 62) for 8 h, and then the ion exchange resin was filtered off. Ion contents: 1 ppm of sulfate, 14 ppm of Na⁺, <20 ppm of iodide.

The resulting formulation was applied with a doctor blade to a poly(ethylene terephthalate) film with a wet film thickness of 60 μm to give a light blue, conductive coating; surface resistance 11 MΩ/sq.

### Example 7

### Preparation of a Poly(3,4-Ethylenedioxythiophene) Dispersion (PEDT:PSS Dispersion) with Iodic Acid as the Oxidizing Agent

A solution of 5.0 g of PSS (molecular weight M_{w}=48 000), 2.0 g of EDT and 104 g of iodic acid in 488.6 g of water was stirred at 50° C. for 100 h. Thereafter, the deep blue reaction mixture was deionized with 41 g each of cation exchanger and anion exchanger (Lewatit® S 100 and Lewatit® MP 62) for 8 h, and then the ion exchange resin was filtered off. 1 g of the resulting formulation was applied with a doctor blade to a PET film mixed with 1 g of methanol and 1 g of acetone and with a wet film layer thickness of 60 μm. After drying at 23° C., a surface resistance of the light blue, conductive film of 230 kΩ/sq was measured.

1-14. (canceled)

15. A process for preparing polythiophenes which comprises oxidatively polymerizing a thiophene or thiophene derivative with an oxidizing agent, wherein the oxidizing agent used is at least one hypervalent iodine compound.

16. The process as claimed in claim 15, wherein the polythiophene contains repeat units of the formula (I) 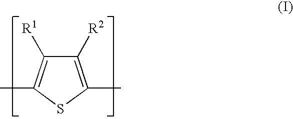
in which
R¹ and R² are each independently H, an optionally substituted C₁-C₁₈-alkyl radical or an optionally substituted C₁-C₁₈-alkoxy radical or
R¹ and R² together are an optionally substituted C₁-C₁₈-alkylene radical, an optionally substituted C₁-C₁₈-alkylene radical in which one or more carbon atom(s) is optionally replaced by one or more identical or different heteroatoms selected from O and S,
said thiophene is of the formula (II) 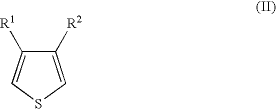
where R¹ and R² are each as defined for the formula (I).

17. The process as claimed in claim 16, wherein
R¹ and R² are each independently H, a C₁-C₈-dioxyalkylene radical, an optionally substituted C₁-C₈-oxythiaalkylene radical or an optionally substituted C₁-C₈-dithiaalkylene radical, or an optionally substituted C₁-C₈-alkylidene radical in which at least one carbon atom is optionally replaced by a heteroatom selected from O and S.

18. The process as claimed in claim 15, wherein the polythiophene contains repeat units of the formula (I-a) and/or (I-b) 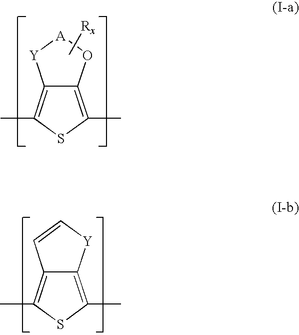
in which
A is an optionally substituted C₁-C₅-alkylene radical,
Y is O or S,
R is a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x is an integer of 0 to 8, and
in the case that a plurality of R radicals is bonded to A, they may be the same or different,
and wherein said thiophene is of the formula (II-a) and/or (II-b)

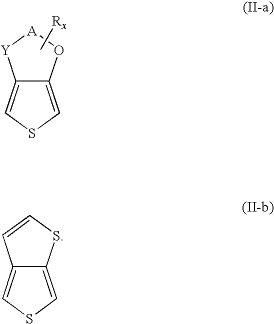

19. The process as claimed in claim 18, wherein
A is an optionally substituted C₂-C₃-alkylene radical and
x is an integer of 0 to 1.

20. The process as claimed in claim 15, wherein poly(3,4-ethylenedioxythiophene) is prepared by oxidatively polymerizing 3,4-ethylenedioxythiophene.

21. The process as claimed in claim 15, wherein the oxidizing agent is an organic or inorganic iodine compound in which the iodine atom is more than monocoordinated and is not present in the formal oxidation state of −1 or 0.

22. The process as claimed in claim 15, wherein the oxidizing agent is an aryl-iodine(III) compound, aryliodonium salt, arylalkyliodonium salt, iodine(III) salt of C₁-C₁₈-alkylsulfonic acid or C₁-C₁₈-alkylcarboxylic acid, or inorganic iodine compound and the alkali metal or alkaline earth metal salt thereof, periodic acid and the alkali metal or alkaline earth metal salt thereof, or the anhydrides derived from these oxygen acids of iodine.

23. The process as claimed in claim 15, wherein the oxidizing agent is bis(acyloxy)iodoaromatics difluoroiodobenzene(V), dichloroiodobenzene (V), iodosylbenzene (VI), hydroxy(tosyloxy)iodobenzene, iodylbenzene (VIII), 1-oxido-1-hydroxybenzoiodoxol-3(1H)-one, 1,1,1-triacetoxy-1,1-dihydro-1,2-benzoiodoxol-3(1H)-one, diaryliodonium salt, diphenyliodonium chloride (XI), phenyl-4-methoxyphenyliodonium triflate (XII), mixed alkylaryliodonium salts which are optionally partly fluorinated or perfluorinated, iodine(III) salts of optionally partly fluorinated or perfluorinated C₁-C₁₈-alkylsulfonic acids or C₁-C₁₈-alkylcarboxylic acids.

24. The process as claimed in claim 15, wherein the oxidative polymerization is carried out in the presence of at least one solvent.

25. The process as claimed in claim 15, wherein the oxidative polymerization is carried out in the presence of at least one counterion.

26. The process as claimed in claim 15, wherein the oxidative polymerization is carried out at temperatures of from −10 to 250° C.

27. The process as claimed in claim 15, wherein the thiophene and oxidizing agent are used in a weight ratio of from 4:1 to 1:20.

28. A process for preparing dispersions comprising optionally substituted polythiophenes by oxidatively polymerizing optionally substituted thiophene or thiophene derivative in the presence of at least one solvent and optionally of at least one counterion, wherein the oxidizing agent used is at least one hypervalent iodine compound.

29. A process for producing a conductive layer comprising optionally substituted polythiophenes, wherein optionally substituted thiophene or thiophene derivative is oxidatively polymerized on a suitable substrate with at least one hypervalent iodine compound as an oxidizing agent in the presence or absence of at least one solvent.

30. The process as claimed in claim 29, wherein the conductive layer is part of a capacitor.
